(19) United States
(12) Patent Application Publication
(10) Pub. No.: US 2022/0058360 A1
(43) Pub. Date: Feb. 24, 2022

(54) LIQUID CRYSTAL DISPLAY DEVICE

(71) Applicant: Wuhan China Star Optoelectronics Technology Co., Ltd., Wuhan (CN)

(72) Inventors: Zhou ZHANG, Wuhan (CN); Pan XU, Wuhan (CN); Changwen MA, Wuhan (CN)

(73) Assignee: Wuhan China Star Optoelectronics Technology Co., Ltd., Wuhan (CN)

(21) Appl. No.: 16/760,461

(22) PCT Filed: Mar. 27, 2020
(86) PCT No.: PCT/CN2020/081652

§ 371 Date: Apr. 30, 2020

(30) Foreign Application Priority Data
Feb. 26, 2020 (CN) 202010118582.9

(51) Int. Cl. G06K 9/00; G02F 1/1333; G02F 1/13357

(52) U.S. Cl. CPC G06K 9/0004; G02F 1/13338; G02F 1/133603; G02F 1/133606; G02F 1/133605

(57) ABSTRACT

A liquid crystal display device, including a fingerprint identification module, a backlight module, a liquid crystal display panel, and a cover plate; the fingerprint identification module has an infrared emitter, an infrared receiver, and a fingerprint optical film. The infrared emitter is positioned at a side of the fingerprint optical film, the infrared receiver is attached to a lower surface of the fingerprint optical film and completely covers the fingerprint optical film, and the infrared receiver is a glass substrate optical readout infrared sensor.

### FIELD OF INVENTION

The present application relates to the field of display technologies, in particular to a liquid crystal display device.

### BACKGROUND OF INVENTION

With development of optical technology and semiconductor technology, flat terminal devices represented by liquid crystal displays (LCDs) have advantages of light weight and thinness, low power consumption, no radiation, good color purity, and high contrast ratio, and have occupied a dominant position in display field. Due to their unique appearance, terminal devices with a high screen-to-body ratio have become more popular products among consumers. In the meantime, since fingerprints are innate, unique, and distinguishable identification features of human body, terminal devices with high screen-to-body ratio and fingerprint recognition function have become a development trend, and optical fingerprint recognition technology is also a current demand of major mobile phone terminals.

A current conventional LCD infrared fingerprint recognition solution, as shown in FIG. 1, is a single-finger touch recognition solution in liquid crystal display devices according to the conventional art. Wherein, an infrared sensor 12 and an infrared light-emitting diode (LED) 11 prepared using a complementary metal oxide semiconductor (SI-CMOS) process are placed under a backlight module 20 in the liquid crystal displays. If there is an iron frame, corresponding openings are needed, as well as film material for use with the backlight module 20 that transmits infrared light, such as a special reflection sheet 21, a light guide plate 22, a diffusion sheet 23, a light enhancement sheet 24, and a visible side-light source 25. When light emitted from the infrared light source 11 penetrates the liquid crystal display through a film structure of the backlight module 20, it reaches a finger 50, and then reaches the infrared sensor 12 for imaging and fingerprint unlocking after refraction and other processes by the finger 50. However, various film layers in the backlight module 20 can seriously interfere with optical fingerprint imaging of an under-screen fingerprint recognition device, which further hinders commercialization of the under-screen fingerprint recognition technology based on the LCD display.

Therefore, how to improve performance of optical fingerprint recognition of the under-screen LCD has become a technical problem to be solved by those skilled in the art.

### TECHNICAL PROBLEM

Various film layer structures in current backlight module will seriously interfere with the optical fingerprint imaging of the under-screen fingerprint recognition device, which further hinders commercialization of the under-screen fingerprint recognition technology based on the LCD display.

### SUMMARY OF INVENTION

### Technical solution

An embodiment of the present application provides a liquid crystal display device, which can effectively increase an optical fingerprint identification region of an under-screen liquid crystal display (LCD), and reduce interference in optical fingerprint imaging of an under-screen recognition device caused by various film structure in a backlight module to further improve fingerprint imaging quality.

In a first aspect, an embodiment of the present application provides a liquid crystal display device, including a fingerprint identification module, a backlight module, a liquid crystal display panel disposed above the backlight module, and a cover plate covering the liquid crystal display panel. The fingerprint identification module includes an infrared emitter, an infrared receiver, and a fingerprint optical film. The fingerprint optical film is attached to a lower surface of the backlight module, the infrared emitter is positioned at a side of the fingerprint optical film, and the infrared receiver is attached to a lower surface of the fingerprint optical film and completely covering the fingerprint optical film. The infrared receiver is a glass substrate optical readout infrared sensor, the fingerprint optical film is used to reflect an infrared light emitted by the infrared emitter toward a fingerprint identification region on a surface of the fingerprint identification module and to reflect the infrared light reflected back from the fingerprint identification region toward the infrared receiver. The fingerprint optical film is further used to transmit visible light emitted by the liquid crystal display panel and the backlight module toward the fingerprint optical film.

In the liquid crystal display device according to an embodiment of the present application, the infrared emitter and a visible backlight of the backlight module are respectively disposed on opposite sides of the liquid crystal display device.

In the liquid crystal display device according to an embodiment of the present application, the backlight module includes a first reflection sheet, a first light guide plate, a diffusion sheet, and a light enhancement sheet laminated along a direction toward the liquid crystal display panel, and the visible backlight is disposed close to a side of the first reflection sheet and a side of the first light guide plate.

In the liquid crystal display device according to an embodiment of the present application, the fingerprint optical film includes a second reflection sheet and a second light guide plate laminated along a direction toward the backlight module, the infrared receiver is attached to a lower surface the second reflection sheet, and the infrared emitter is disposed close to a side of the second reflection sheet and a side of the second light guide plate.

In the liquid crystal display device according to an embodiment of the present application, the backlight module includes a reflection sheet, a double-layered light guide plate, a diffusion sheet, and a light enhancement sheet laminated along a direction toward the liquid crystal display panel, and wherein the double-layered light guide plate includes an upper light guide plate and a lower light guide plate, and a visible backlight is disposed close to a side of the upper light guide plate.

In the liquid crystal display device according to an embodiment of the present application, the fingerprint optical film includes the lower light guide plate and the reflection sheet, the infrared receiver is attached to a lower surface of the reflection sheet, and the infrared emitter is disposed close to a side of the reflection sheet and a side of the lower light guide plate.

In the liquid crystal display device according to an embodiment of the present application, the visible backlight and the infrared emitter are positioned at a same side of the liquid crystal display device and are connected in series to each other, the visible backlight emits visible light, and the infrared emitter emits infrared light.

In the liquid crystal display device according to an embodiment of the present application, a method of connection in series is a method in which a visible light-emitting diode (LED) light bar and an infrared LED light bar are alternately distributed.

In the liquid crystal display device according to an embodiment of the present application, a method of connection in series is a method in which a dual-core LED consists of a visible light and an infrared light.

In a second aspect, an embodiment of the present application further provides a liquid crystal display device, including a fingerprint identification module; a backlight module; a liquid crystal display panel disposed above the backlight module; and a cover plate covering the liquid crystal display panel; wherein the fingerprint identification module includes an infrared emitter, an infrared receiver, and a fingerprint optical film, the fingerprint optical film is attached to a lower surface of the backlight module, the infrared emitter is positioned at a side of the fingerprint optical film, and the infrared receiver is attached to a lower surface of the fingerprint optical film and completely covering the fingerprint optical film, and wherein the infrared receiver is a glass substrate optical readout infrared sensor.

In the liquid crystal display device according to an embodiment of the present application, the backlight module includes a reflection sheet, a double-layered light guide plate, a diffusion sheet, and a light enhancement sheet laminated along a direction toward the liquid crystal display panel, and wherein the double-layered light guide plate includes an upper light guide plate and a lower light guide plate, and a visible backlight is disposed close to a side of the upper light guide plate.

In the liquid crystal display device according to an embodiment of the present application, the fingerprint optical film includes the lower light guide plate and the reflection sheet, the infrared receiver is attached to a lower surface of the reflection sheet, and the infrared emitter is disposed close to a side of the reflection sheet and a side of the lower light guide plate.

In the liquid crystal display device according to an embodiment of the present application, the visible backlight and the infrared emitter are positioned at a same side of the liquid crystal display device and are connected in series to each other, the visible backlight emits visible light, and the infrared emitter emits infrared light.

In the liquid crystal display device according to an embodiment of the present application, a method of connection in series is a method in which a visible light-emitting diode (LED) light bar and an infrared LED light bar are alternately distributed.

In the liquid crystal display device according to an embodiment of the present application, a method of connected in series to each other is a dual-core LED consisted of a visible light and an infrared light.

An embodiment of the present application further provides a liquid crystal display device, including a fingerprint identification module; a backlight module; a liquid crystal display panel disposed above the backlight module; and a cover plate covering the liquid crystal display panel; wherein the fingerprint identification module includes an infrared emitter, an infrared receiver, and a fingerprint optical film, the fingerprint optical film attached to a lower surface of the backlight module, the infrared emitter positioned at a side of the fingerprint optical film, and the infrared receiver attached to a lower surface of the fingerprint optical film and completely covering the fingerprint optical film; wherein the infrared receiver is a glass substrate optical readout infrared sensor; wherein the backlight module includes a reflection sheet, a double-layered light guide plate, a diffusion sheet, and a light enhancement sheet laminated along a direction toward the liquid crystal display panel, and wherein the double-layered light guide plate includes an upper light guide plate and a lower light guide plate, and a visible backlight is disposed close to a side of the upper light guide plate.

In the liquid crystal display device according to an embodiment of the present application, the fingerprint optical film includes the lower light guide plate and the reflection sheet, the infrared receiver is attached to a lower surface of the reflection sheet, and the infrared emitter is disposed close to a side of the reflection sheet and a side of the lower light guide plate.

In the liquid crystal display device according to an embodiment of the present application, the visible backlight and the infrared emitter are positioned at a same side of the liquid crystal display device and are connected in series to each other, the visible backlight emits visible light, and the infrared emitter emits infrared light.

In the liquid crystal display device according to an embodiment of the present application, a method of connection in series is a method in which a visible light-emitting diode (LED) light bar and an infrared LED light bar are alternately distributed.

In the liquid crystal display device according to an embodiment of the present application, a method of connection in series is a method in which a dual-core LED consists of a visible light and an infrared light.

In the liquid crystal display device according to an embodiment of the present application,

### Beneficial Effect

Compared with the conventional art, the liquid crystal display device according to the embodiments of the present application, by setting the infrared receiver as a glass substrate optical readout infrared sensor and completely covering the fingerprint optical film, so that an infrared side-light source is diffusely reflected by the fingerprint optical film to form a planar light source, further improves fingerprint recognition image quality and fingerprint recognition performance.

### BRIEF DESCRIPTION OF FIGURES

FIG. 1 is a schematic structural diagram of a liquid crystal display device according to conventional art.

FIG. 2 is a schematic structural diagram of a liquid crystal display device according to a first embodiment of the present application.

FIG. 3 is a schematic structural diagram of a liquid crystal display device according to a second embodiment of the present application.

FIG. 4 is a schematic structural diagram of a liquid crystal display device according to a third embodiment of the present application.

FIG. 5 is a schematic diagram of a visible light-emitting diode (LED) light bar and an infrared LED light bar alternatively distributed in the liquid crystal display device according to the third embodiment of the present application.

FIG. 6 is a schematic diagram of a visible and infrared dual-core LED light bar in the liquid crystal display device according to the third embodiment of the present application.

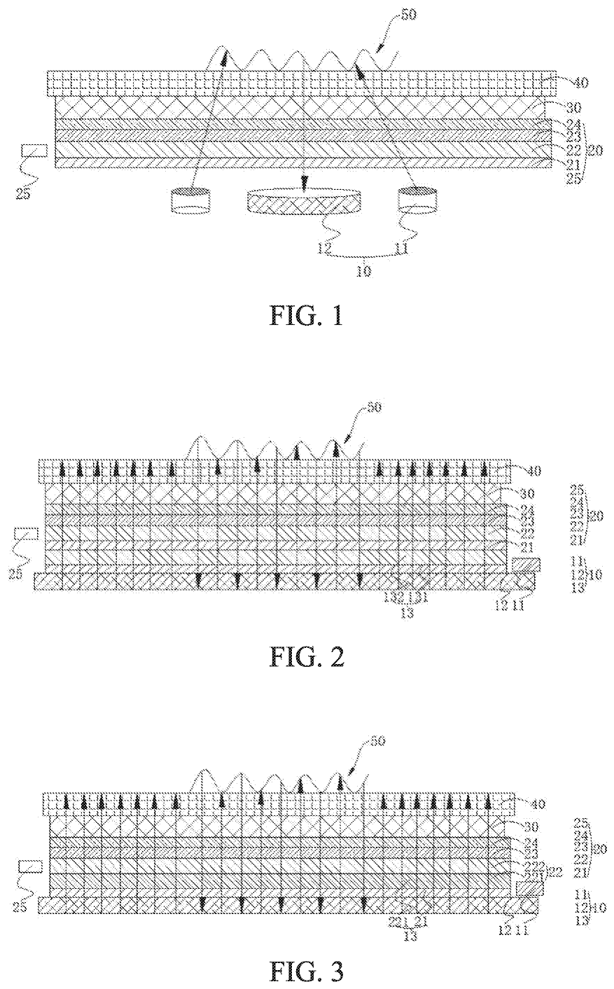

### DETAILED DESCRIPTION OF EMBODIMENTS

Shown in FIG. 2 is a schematic structural diagram of a liquid crystal display device according to a first embodiment of the present application. The liquid crystal display device includes a fingerprint identification module 10, a backlight module 20, a liquid crystal display panel 30 disposed above the backlight module 20, and a cover plate 40 covering the liquid crystal display panel 30. The fingerprint identification module 10 includes an infrared emitter 11, an infrared receiver 12, and a fingerprint optical film 13. The fingerprint optical film 13 is attached to a lower surface of the backlight module 20, the infrared emitter 12 is positioned at a side of the fingerprint optical film 13, and the infrared receiver 12 is attached to a lower surface of the fingerprint optical film 13 and completely covering the fingerprint optical film 13. The infrared receiver 12 is a glass substrate optical readout infrared sensor, which uses a glass substrate that transmits visible light but not infrared light.

Specifically, the fingerprint optical film 13 is used to reflect an infrared light emitted by the infrared emitter 11 toward a fingerprint identification region on a surface of the fingerprint identification module 10 and to reflect the infrared light reflected back from the fingerprint identification region toward the infrared receiver 12, and the fingerprint optical film 13 is further used to transmit visible light emitted by the liquid crystal display panel 30 and the backlight module 20 toward the fingerprint optical film 13.

Specifically, the backlight module 20 includes a first reflection sheet 21, a first light guide plate 22, a diffusion sheet 23, and a light enhancement sheet 24 laminated along a direction toward the liquid crystal display panel 30. The backlight module 20 further includes a visible backlight 25, the visible backlight 25 is disposed close to a side of the first reflection sheet 21 and a side of the first light guide plate 22. In this case, the backlight module 20 is a side-lit backlight module, and various film structure in the backlight module 20 can transmit infrared light.

Preferably, the visible backlight 25 is a visible light-emitting diode (LED) light bar. The light enhancement sheet 24 can include a prism film (brightness enhancement film, BEF) and a reflective polarization enhancement film (dual brightness enhancement film, DBEF), both of which can be used in combination.

Specifically, the fingerprint optical film 13 includes a second reflection sheet 131 and a second light guide plate 132 laminated along a direction toward the backlight module 20. The infrared receiver 12 is attached to a lower surface of the second reflection sheet 131, and the infrared emitter 11 is disposed close to a side of the second reflection sheet 131 and a side of the second light guide plate 132.

Preferably, the infrared emitter 11 and the visible backlight 25 are respectively disposed on opposite sides of the liquid crystal display device, and the infrared emitter 11 is an infrared LED light bar.

Specifically, the liquid crystal display panel 30 includes an array substrate (not shown in FIG. 2), an opposite substrate (not shown in FIG. 2), and a liquid crystal layer disposed between the array substrate and the opposite substrate (not shown in FIG. 2). The array substrate and the opposite substrate are paired together by a frame sealant (not shown in FIG. 2), thereby defining the liquid crystal layer within a region enclosed by the frame sealant. When a color filter layer (not shown in FIG. 2) is disposed on the opposite substrate, the opposite substrate is a color filter substrate.

Preferably, material of the cover plate 40 is transparent glass.

In the liquid crystal display device according to the first embodiment of the present application, both the second reflection sheet 131 and the second light guide plate 132 need to reflect infrared light emitted by the infrared emitter 11, and the infrared light emitted by the infrared emitter 11 is diffusely reflected by the second light guide plate 132 to form a planar light source. The reflected infrared light passes through the backlight module 20 and penetrates the liquid crystal display panel 30 to reach the finger 50. The infrared light after being refracted by the finger 50 is fed back to the infrared receiver 12 for imaging and fingerprint unlocking.

Shown in FIG. 3 is a schematic structural diagram of a liquid crystal display device according to a second embodiment of the present application. The liquid crystal display device includes a fingerprint identification module 10, a backlight module 20, a liquid crystal display panel 30 disposed above the backlight module 20, and a cover plate 40 covering the liquid crystal display panel 30. The fingerprint identification module 10 includes an infrared emitter 11, an infrared receiver 12, and a fingerprint optical film 13. The fingerprint optical film 13 is attached to a lower surface of the backlight module 20, and the infrared emitter 12 is positioned at a side of the fingerprint optical film 13. The infrared receiver 12 is attached to a lower surface of the fingerprint optical film 13 and completely covers the fingerprint optical film 13. The infrared receiver 12 is a glass substrate optical readout infrared sensor, which uses a glass substrate that transmits visible light but not infrared light.

Specifically, the fingerprint optical film 13 is used to reflect an infrared light emitted by the infrared emitter 11 toward a fingerprint identification region on a surface of the fingerprint identification module 10 and to reflect the infrared light reflected back from the fingerprint identification region toward the infrared receiver 12, and the fingerprint optical film 13 is further used to transmit visible light emitted by the liquid crystal display panel 30 and the backlight module 20 toward the fingerprint optical film 13.

Specifically, the backlight module 20 includes a first reflection sheet 21, a double-layered light guide plate 22, a diffusion sheet 23, and a light enhancement sheet 24 laminated along a direction toward the liquid crystal display panel 30. The double-layered light guide plate 22 includes an upper light guide plate 222 and a lower light guide plate 221. The backlight module 20 further includes a visible backlight 25, the visible backlight 25 is disposed close to a side of the upper light guide plate 22. In this case, the backlight module 20 is a side-lit backlight module, and various film structure in the backlight module 20 can transmit infrared light.

Preferably, the visible backlight 25 is a visible LED light bar. The light enhancement sheet 24 can include a prism film (brightness enhancement film, BEF) and a reflective polarization enhancement film (dual brightness enhancement film, DBEF), both of which can be used in combination.

Specifically, the fingerprint optical film 13 includes the lower light guide plate 221 and the reflection sheet 21. The infrared receiver 12 is attached to a lower surface of the reflection sheet 21, and the infrared emitter 11 is disposed close to a side of the reflection sheet 21 and a side of the lower light guide plate 221.

Preferably, the infrared emitter 11 and the visible backlight 25 are respectively disposed on opposite sides of the liquid crystal display device, and the infrared emitter 11 is an infrared LED light bar.

Specifically, the liquid crystal display panel 30 includes an array substrate (not shown in FIG. 3), an opposite substrate (not shown in FIG. 3), and a liquid crystal layer disposed between the array substrate and the opposite substrate (not shown in FIG. 3). The array substrate and the opposite substrate are paired together by a frame sealant (not shown in FIG. 3), thereby defining the liquid crystal layer within a region enclosed by the frame sealant. When a color filter layer (not shown in FIG. 3) is disposed on the opposite substrate, the opposite substrate is a color filter substrate.

Preferably, material of the cover plate 40 is transparent glass.

In the liquid crystal display device according to the second embodiment of the present application, the light guide plate adopts a double-layered special design, the upper light guide plate 222 converts visible light into a planar light source, and the lower light guide plate 221 converts infrared light into a planar light source. Both the reflection sheet 21 and the lower light guide plate 221 need to reflect the infrared light emitted by the infrared emitter 11, and the lower light guide plate 221 diffusely reflects the infrared light emitted by the infrared emitter 11 to form a planar light source. The reflected infrared light passes through the backlight module 20 and penetrates the liquid crystal display panel 30 to reach the finger 50. The infrared light after being refracted by the finger 50 is fed back to the infrared receiver 12 for imaging and fingerprint unlocking.

Compared with the liquid crystal display device according to the first embodiment of the present application, the liquid crystal display device according to the second embodiment of the present application has a partial film structure reduced so that interference in fingerprint imaging of an under-screen recognition device caused by various film structure in the liquid crystal display device is reduced, which further improves the fingerprint recognition image quality and fingerprint recognition performance.

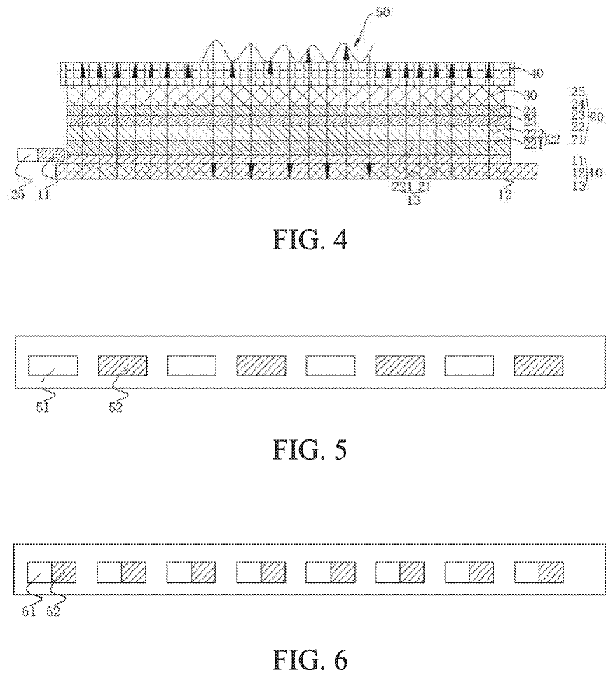

Shown in FIG. 4 is a schematic structural diagram of a liquid crystal display device according to a third embodiment of the present application. The liquid crystal display device includes a fingerprint identification module 10, a backlight module 20, a liquid crystal display panel 30 disposed above the backlight module 20, and a cover plate 40 covering the liquid crystal display panel 30. The fingerprint identification module 10 includes an infrared emitter 11, an infrared receiver 12, and a fingerprint optical film 13. The fingerprint optical film 13 is attached to a lower surface of the backlight module 20, and the infrared emitter 12 is positioned at a side of the fingerprint optical film 13. The infrared receiver 12 is attached to a lower surface of the fingerprint optical film 13 and completely covers the fingerprint optical film 13. The infrared receiver 12 is a glass substrate optical readout infrared sensor, which uses a glass substrate that transmits visible light but not infrared light.

Among them, a visible backlight and the infrared emitter are positioned at a same side of the liquid crystal display device and are connected in series to each other, the visible backlight emits visible light, and the infrared emitter emits infrared light.

Specifically, the fingerprint optical film 13 is used to reflect an infrared light emitted by the infrared emitter 11 toward a fingerprint identification region on a surface of the fingerprint identification module 10 and to reflect the infrared light reflected back from the fingerprint identification region toward the infrared receiver 12, and the fingerprint optical film 13 is further used to transmit visible light emitted by the liquid crystal display panel 30 and the backlight module 20 toward the fingerprint optical film 13.

Specifically, the liquid crystal display panel 30 includes an array substrate (not shown in FIG. 3), an opposite substrate (not shown in FIG. 3), and a liquid crystal layer disposed between the array substrate and the opposite substrate (not shown in FIG. 3). The array substrate and the opposite substrate are paired together by a frame sealant (not shown in FIG. 3), thereby defining the liquid crystal layer within a region enclosed by the frame sealant. When a color filter layer (not shown in FIG. 3) is disposed on the opposite substrate, the opposite substrate is a color filter substrate.

Preferably, material of the cover plate 40 is transparent glass.

Specifically, the backlight module 20 includes a reflection sheet 21, a double-layered light guide plate 22, a diffusion sheet 23, and a light enhancement sheet 24 laminated along a direction toward the liquid crystal display panel 30. The double-layered light guide plate 22 includes an upper light guide plate 222 and a lower light guide plate 221. The backlight module 20 further includes a visible backlight 25, the visible backlight 25 is disposed close to a side of the upper light guide plate 222. In this case, the backlight module 20 is a side-lit backlight module, and various film structure in the backlight module 20 can transmit infrared light.

Preferably, the visible backlight 25 is a visible LED light bar. The light enhancement sheet 24 can include a prism film (brightness enhancement film, BEF) and a reflective polarization enhancement film (dual brightness enhancement film, DBEF), both of which can be used in combination.

Specifically, the fingerprint optical film 13 includes the lower light guide plate 221 and the reflection sheet 21, and the infrared receiver 12 is attached to a lower surface of the reflection sheet 21. The infrared emitter 11 and the visible backlight 25 are connected to each other in serious, and are disposed close to a side of the reflection sheet 21 and a side of the lower light guide plate 221.

Shown in FIG. 5 is a schematic diagram of a visible LED light bar and an infrared LED light bar alternatively distributed in the liquid crystal display device according to the third embodiment of the present application. Wherein, a method of connection in series is a method in which a visible LED light bar 51 and an infrared LED light bar 52 are alternately distributed.

As shown in FIG. 6, which is a schematic diagram of a visible and infrared dual-core LED light bar in the liquid crystal display device according to the third embodiment of the present application. Wherein, a method of connection in series is a method in which a dual-core LED consists of a visible light 61 and an infrared light 61.

In the liquid crystal display device according to the third embodiment of the present application, the visible light LED bar and the infrared light LED bar are connected in series to each other and are positioned at the same side of the liquid crystal display device. The light guide plate adopts a double-layered special design, the upper light guide plate 222 converts visible light into a planar light source, and the lower light guide plate 221 converts infrared light into a planar light source. Both the reflection sheet 21 and the lower light guide plate 221 need to reflect the infrared light emitted by the infrared emitter 11, and the lower light guide plate 221 diffusely reflects the infrared light emitted by the infrared emitter 11 to form a planar light source. The reflected infrared light passes through the backlight module 20 and penetrates the liquid crystal display panel 30 to reach the finger 50. The infrared light after being refracted by the finger 50 is fed back to the infrared receiver 12 for imaging and fingerprint unlocking.

Compared with the liquid crystal display device according to the second embodiment of the present application, the liquid crystal display device according to the third embodiment of the present application combines the visible LED light bar and the infrared LED light bar together, reducing a partial film structure, so that interference in fingerprint imaging of an under-screen recognition device caused by various film structure in the liquid crystal display device is reduced, which further improves the fingerprint recognition image quality and fingerprint recognition performance.

The liquid crystal display device according to the embodiments of the present application, by setting the infrared receiver as a glass substrate optical readout infrared sensor and completely covering the fingerprint optical film, so that an infrared side-light source is diffusely reflected by the fingerprint optical film to form a planar light source, further improves fingerprint recognition image quality and fingerprint recognition performance.

Specific implementation of above operations can refer to previous embodiments, and will not be repeated here.

In summary, the liquid crystal display device according to the embodiments of the present application prevents cracks generated from bending a flexible display panel due to poor ductility of an inorganic layer in a cutting process, without increasing mask plate and process flow, and further ensures display performance of the flexible display panel.

It can be understood that, for a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A liquid crystal display device, comprising:
a fingerprint identification module;
a backlight module;
a liquid crystal display panel disposed above the backlight module; and
a cover plate covering the liquid crystal display panel;
wherein the fingerprint identification module comprises an infrared emitter, an infrared receiver, and a fingerprint optical film, the fingerprint optical film is attached to a lower surface of the backlight module, the infrared emitter is positioned at a side of the fingerprint optical film, and the infrared receiver is attached to a lower surface of the fingerprint optical film and completely covering the fingerprint optical film; and
wherein the infrared receiver is a glass substrate optical readout infrared sensor, the fingerprint optical film is used to reflect an infrared light emitted by the infrared emitter toward a fingerprint identification region on a surface of the fingerprint identification module and to reflect the infrared light reflected back from the fingerprint identification region toward the infrared receiver, and the fingerprint optical film is further used to transmit visible light emitted by the liquid crystal display panel and the backlight module toward the fingerprint optical film.

2. The liquid crystal display device according to claim 1, wherein the infrared emitter and a visible backlight of the backlight module are respectively disposed on opposite sides of the liquid crystal display device.

3. The liquid crystal display device according to claim 2, wherein the backlight module comprises a first reflection sheet, a first light guide plate, a diffusion sheet, and a light enhancement sheet laminated along a direction toward the liquid crystal display panel, and the visible backlight is disposed close to a side of the first reflection sheet and a side of the first light guide plate.

4. The liquid crystal display device according to claim 3, wherein the fingerprint optical film comprises a second reflection sheet and a second light guide plate laminated along a direction toward the backlight module, the infrared receiver is attached to a lower surface the second reflection sheet, and the infrared emitter is disposed close to a side of the second reflection sheet and a side of the second light guide plate.

5. The liquid crystal display device according to claim 1, wherein the backlight module comprises a reflection sheet, a double-layered light guide plate, a diffusion sheet, and a light enhancement sheet laminated along a direction toward the liquid crystal display panel, and wherein the double-layered light guide plate comprises an upper light guide plate and a lower light guide plate, and a visible backlight is disposed close to a side of the upper light guide plate.

6. The liquid crystal display device according to claim 5, wherein the fingerprint optical film comprises the lower light guide plate and the reflection sheet, the infrared receiver is attached to a lower surface of the reflection sheet, and the infrared emitter is disposed close to a side of the reflection sheet and a side of the lower light guide plate.

7. The liquid crystal display device according to claim 6, wherein the visible backlight and the infrared emitter are positioned at a same side of the liquid crystal display device and are connected in series to each other, the visible backlight emits visible light, and the infrared emitter emits infrared light.

8. The liquid crystal display device according to claim 7, wherein a method of connection in series is a method in which a visible light-emitting diode (LED) light bar and an infrared LED light bar are alternately distributed.

9. The liquid crystal display device according to claim 7, wherein a method of connection in series is a method in which a dual-core LED consists of a visible light and an infrared light.

10. A liquid crystal display device, comprising:
a fingerprint identification module;
a backlight module;
a liquid crystal display panel disposed above the backlight module; and
a cover plate covering the liquid crystal display panel;
wherein the fingerprint identification module comprises an infrared emitter, an infrared receiver, and a fingerprint optical film, the fingerprint optical film is attached to a lower surface of the backlight module, the infrared emitter is positioned at a side of the fingerprint optical film, and the infrared receiver is attached to a lower surface of the fingerprint optical film and completely covering the fingerprint optical film; and
wherein the infrared receiver is a glass substrate optical readout infrared sensor.

11. The liquid crystal display device according to claim 10, wherein the backlight module comprises a reflection sheet, a double-layered light guide plate, a diffusion sheet, and a light enhancement sheet laminated along a direction toward the liquid crystal display panel, and wherein the double-layered light guide plate comprises an upper light guide plate and a lower light guide plate, and a visible backlight is disposed close to a side of the upper light guide plate.

12. The liquid crystal display device according to claim 11, wherein the fingerprint optical film comprises the lower light guide plate and the reflection sheet, the infrared receiver is attached to a lower surface of the reflection sheet, and the infrared emitter is disposed close to a side of the reflection sheet and a side of the lower light guide plate.

13. The liquid crystal display device according to claim 12, wherein the visible backlight and the infrared emitter are positioned at a same side of the liquid crystal display device and are connected in series to each other, the visible backlight emits visible light, and the infrared emitter emits infrared light.

14. The liquid crystal display device according to claim 13, wherein a method of connection in series is a method in which a visible light-emitting diode (LED) light bar and an infrared LED light bar are alternately distributed.

15. The liquid crystal display device according to claim 13, wherein a method of connected in series is a method in which a dual-core LED consists of a visible light and an infrared light.

16. A liquid crystal display device, comprising:
a fingerprint identification module;
a backlight module;
a liquid crystal display panel disposed above the backlight module; and
a cover plate covering the liquid crystal display panel;
wherein the fingerprint identification module comprises an infrared emitter, an infrared receiver, and a fingerprint optical film, the fingerprint optical film attached to a lower surface of the backlight module, the infrared emitter positioned at a side of the fingerprint optical film, and the infrared receiver attached to a lower surface of the fingerprint optical film and completely covering the fingerprint optical film;
wherein the infrared receiver is a glass substrate optical readout infrared sensor;
wherein the backlight module comprises a reflection sheet, a double-layered light guide plate, a diffusion sheet, and a light enhancement sheet laminated along a direction toward the liquid crystal display panel; and
wherein the double-layered light guide plate comprises an upper light guide plate and a lower light guide plate, and a visible backlight is disposed close to a side of the upper light guide plate.

17. The liquid crystal display device according to claim 16, wherein the fingerprint optical film comprises the lower light guide plate and the reflection sheet, the infrared receiver is attached to a lower surface of the reflection sheet, and the infrared emitter is disposed close to a side of the reflection sheet and a side of the lower light guide plate.

18. The liquid crystal display device according to claim 17, wherein the visible backlight and the infrared emitter are positioned at a same side of the liquid crystal display device and are connected in series to each other, the visible backlight emits visible light, and the infrared emitter emits infrared light.

19. The liquid crystal display device according to claim 18, wherein a method of connection in series is a method in which visible light-emitting diode (LED) light bar and an infrared LED light bar are alternately distributed.

20. The liquid crystal display device according to claim 18, wherein a method of connection in series is a method in which a dual-core LED consists of a visible light and an infrared light.
